(19) United States
(12) Patent Application Publication
(10) Pub. No.: US 2005/0000074 A1
(43) Pub. Date: Jan. 6, 2005

(54) Wheel lift

(76) Inventor: Constantinos Tsatsis, Lynnfield, MA (US)

Correspondence Address: George E. Kersey, P.O. Box 1073, Framingham, MA, 01701, US

(21) Appl. No.: 10/898,731

(22) Filed: Jul. 26, 2004

Related U.S. Application Data
(63) Continuation-in-part of application No. 10/361,117, filed on Feb. 10, 2003.

(51) Int. Cl. B23P 6/00; B29C 73/00

(52) U.S. Cl. 29/402.08; 29/402.03; 29/402.01; 254/45

(57) ABSTRACT

Method and apparatus for elevating an object by a member secured to the object for the elevation thereof; and a mechanism for operating the elevation member, which can be positioned beneath the object, such as a vehicle, where the elevation member is a source of fluid pressure, which can be gaseous or hydraulic and is connected to the member for elevating the vehicle or a portion thereof such as a wheel.

### FIELD OF THE INVENTION

This is a continuation-in-part of Ser. No. 10/361,117, filed Feb. 10, 2003. The invention relates to a wheel lift, and more specifically to a wheel lift for a vehicle.

### BACKGROUND OF THE INVENTION

It often is necessary to elevate an object such as a vehicle. This is typically the case where it becomes necessary to change a tire or otherwise have access to the underside of the vehicle, for example, to replace a defective part or to install an accessory.

In the case of tire changing, it is common practice to employ a manual jack that is removed from the trunk compartment and placed under the frame of the vehicle in the vicinity of the item such as a tire to which access is desired.

This approach to tire changing has many drawbacks. In the first place, when a tire defect occurs while a vehicle is in motion, it is necessary to pull off the roadway and seek a level area where the use of the ordinary jack will not cause difficulty. In addition, it is necessary for the operator of the vehicle to open the door and often face on-coming traffic with the possible consequence that the driver with a defective tire will be struck by a passing vehicle while in the course of removing the jack from its storage compartment and then attempting to jack up the vehicle.

Not only are there traffic hazards, but the jack must be properly positioned with respect to the frame, otherwise the vehicle can become damaged during the jacking operation and in some cases, give rise to an instability that may cause the vehicle to fall after its been jacked.

As an alternative to having the driver or occupant of a vehicle attempt to elevate a tire that needs changing, a call can be made to a service organization that can avoid the foregoing difficulties by employing a hydraulic jack to properly elevate the wheel.

Unfortunately, before use can be made of the hydraulic jack on a service vehicle, it usually is necessary to have precise alignment between the service vehicle and the vehicle being served. In crowded lots and along curbsides, where heavy traffic restricts movement, the ordinary service vehicle lift proves to be cumbersome and fails to give the operator sufficient flexibility.

Further, the ordinary designs are not adapted to provide fully automatic connections, thus forcing the driver of the service vehicle to leave the cab to elevate the wheel.

Peterson, U.S. Pat. No. 3,484,817 discloses a lift which employs manually deployable fork elements. In operation, a lift-boom is lowered and a wheel fork is manually unfolded. Support rods, located at the distal ends of the fork, are then manually removed from the fork, to surround the wheel. In this position, the support rods are replaced, forming rectangular frames whose longitudinal sides are shorter than the diameter of the tire. The forks and vehicle are then raised. The forks, however, must be precisely aligned with the tire, requiring the operator to back up the forks within about a half-foot from the center line of the tires. Further, the tow operation requires at least three manual steps: two before the wheels are engaged and one after the wheel has been engaged.

Haring, U.S. Pat. No. 4,034,873 discloses a sling which can be placed under a tire by abutting a pair of slant bars next to the tire and by then securing the bars to the tires by a pair of adjustable bars. As a result, a cradle is formed about the tire when being raised. Therefore, the operation is both time-consuming and may require more than one operator.

Young Blood, U.S. Pat. No. 4,186,938, discloses a lift arrangement which requires attachment of a bar directly to the frame of the vehicle. The bar must be manually attached to the vehicle and requires precise alignment with the vehicle frame in order to place the ends of the bar in direct communication with holes in the frame. Young Blood, as a result, also requires precise alignment and may need two operators to achieve alignment. Young Blood does not benefit from attaching a connection to a point where the suspension system of the vehicle can be used as a shock absorber.

Prior art vehicle wheel lift devices require complex or difficult maneuvers to correctly align the vehicle lift system, or entail manual manipulation to securely connect the apparatus to the vehicle.

Accordingly, it is an object of the invention to overcome the deficiencies of the prior art by providing a wheel lift which can be easily operated.

Another object of the invention is to facilitate the elevation of an object such as a vehicle, particularly where it becomes necessary to change a tire or otherwise have access to the underside of the vehicle, for example, to replace a defective part or to install an accessory.

A further object of the invention is to avoid the need for to employ a manual jack that has to be removed from a trunk or other compartment and placed under the frame of the vehicle, in the vicinity of the item such as a tire to which access is desired.

A still further object of the invention is to avoid the need when a tire defect occurs while a vehicle is in motion, to pull off the roadway and seek a level area where the use of the ordinary jack will not cause difficulty. A related object is to avoid the need for the operator of the vehicle to open the door and often face on-coming traffic with the possible consequence that the driver with a defective tire will be struck by a passing vehicle while in the course of removing the jack from its storage compartment and then attempting to jack up the vehicle.

Another object of the invention is to avoid the need for having the jack properly positioned with respect to the frame, so that the vehicle cannot become damaged during the jacking operation, and in some cases, give rise to an instability that may cause the vehicle to fall after its been jacked.

Still another object of the invention is to avoid having the driver or occupant of a vehicle attempt to elevate a tire that needs changing by making a call to a service organization to employ a jack to properly elevate the wheel. A related object is to avoid the need, before use can be made of the jack on a service vehicle, of the necessity to have precise alignment between the service vehicle and the vehicle being served. In crowded lots and along curbsides, where heavy traffic restricts movement, the ordinary service vehicle lift proves to be cumbersome and fails to give the operator sufficient flexibility.

A further object of the invention is to avoid the need for having the driver of the service vehicle to leave the cab to elevate the wheel. A related object is to avoid the difficulties associated with Peterson, U.S. Pat. No. 3,484,817 which discloses a lift employing manually deployable fork elements. The forks must be precisely aligned with the tire, requiring the operator to back up the forks within about a half-foot from the center line of the tires. Further, the tow operation requires at least three manual steps: two before the wheels are engaged and one after the wheel has been engaged.

A still further object of the invention is to avoid the difficulties associated with Haring, U.S. Pat. No. 4,034,873 which discloses a sling that can be placed under a tire by abutting a pair of slant bars next to the tire and by then securing the bars to the tires by a pair of adjustable bars. As a result, a cradle is formed about the tire when being raised. Therefore, the operation is both time-consuming and may require more than one operator.

Yet another object of the invention is avoid the difficulties associated with Young Blood, U.S. Pat. No. 4,186,938, which discloses a lift arrangement that requires attachment of a bar directly to the frame of the vehicle. The bar must be manually attached to the vehicle and requires precise alignment with the vehicle frame in order to place the ends of the bar in direct communication with holes in the frame. Young Blood, as a result, also requires precise alignment and may need two operators to achieve alignment. Young Blood does not benefit from attaching a connection to a point where the suspension system of the vehicle can be used as a shock absorber.

Prior art vehicle wheel lift devices require complex or difficult maneuvers to correctly align the vehicle lift system, or entail manual manipulation to securely connect the apparatus to the vehicle.

### SUMMARY OF THE INVENTION

In accomplishing the foregoing and related objects, the invention provides for elevating an object by a mechanism secured to the object for the elevation thereof, and for operating the elevating mechanism.

In accordance with one aspect of the invention, the elevating mechanism is positioned beneath the object, which can be a vehicle.

In accordance with another aspect of the invention, the elevating mechanism is operated from a source of fluid pressure, which can be gaseous or liquid, such as hydraulic.

In accordance with a further aspect of the invention the source of fluid pressure is connected to a device for elevating the vehicle, and more particularly fluid pressure is applied to said elevating mechanism in order to elevate a wheel of the vehicle. The source of fluid pressure can be rechargeable.

In a method of the invention for elevating an object the steps include (a) securing to the object a mechanism for the elevation thereof, and (b) operating the elevation mechanism. The invention further includes the step of positioning the elevation mechanism beneath the object and attaching the elevation mechanism beneath the vehicle.

The invention also includes the step of providing the elevation mechanism with a source of fluid pressure that can be gaseous, fluidic or hydraulic. The source of fluid pressure is connected to a device for elevating the vehicle, such as a wheel thereof Fluid pressure is applied to the elevating mechanism in order to elevate a wheel of the vehicle, and the fluid source is rechargeable.

In a method of the invention providing for the repair of a flat tire on a vehicle, the steps include: (a) loosening the flat tire from the vehicle; (b) elevating the tire by a mechanism at a fixed position beneath the vehicle for the elevation of the flat tire; (c) Removing the flat tire from the vehicle at the elevated position of the tire; (d) replacing the flat tire by a suitably inflated tire on the vehicle; and (e) lowering the inflated tire by the mechanism at the fixed position beneath the vehicle.

The invention also provides apparatus for elevating an object having a front portion and a rear portion by a single lift centrally secured beneath the object for the elevation thereof; and a further mechanism for operating the elevation mechanism, wherein said single lift selectively lifts the entire portions of the object.

In accordance with another aspect of the invention the elevating mechanism lifts an entire front portion or an entire rear portion. The object can have a chassis and the elevation mechanism is centrally positioned beneath the chassis. When the object is a vehicle, the elevation mechanism can be a source of fluid pressure connected to the mechanism for elevating the vehicle. The elevating mechanism can elevate a plurality of wheels of the vehicle simultaneously. The fluid pressure can be selected from the class consisting of gaseous, liquid and hydraulic fluids, and the source of fluid pressure can be rechargeable.

In accordance with a method of the invention for providing for the repair of a flat tire on a vehicle, the steps include: (a) loosening the flat tire from said vehicle; (b) elevating the tire by a mechanism at a fixed position beneath the vehicle for the elevation of the flat tire wherein the mechanism for elevating comprises a single lift for selectively lifting the entire front or back portion of the vehicle; (c) removing the flat tire from the vehicle at the elevated position of the tire; (d) replacing the flat tire by a suitably inflated tire on the vehicle; (e) lowering the inflated d tire by the mechanism at the fixed position beneath the vehicle.

A method of the invention for elevating an object having a plurality of sides include the steps of securing to the object a centrally located mechanism for the elevation selectively of an entire side of the object; and (b) operating the elevation mechanism. The method further includes the step of positioning the elevation mechanism beneath the object, and the step of attaching the elevation mechanism beneath a vehicle, and further providing the elevation mechanism with a source of fluid pressure.

The methods further includes the step of connecting a source of fluid pressure to the mechanism for elevating the vehicle, elevating a wheel of the vehicle, applying fluid pressure, including gaseous or hydraulic fluid pressure, to the elevating mechanism in order to elevate a wheel of the vehicle,

The source pressure can be gaseous and be externally recharged.

### BRIEF DESCRIPTION OF THE DRAWINGS

Various other features, advantages and characteristics of the invention will become apparent after considering several illustrative embodiments, taken in conjunction with the drawings, in which:

FIG. 1 is a perspective view of a vehicle for which the left front tire has been elevated by a fluid actuated jack fixed beneath the vehicle and operated from within the vehicle.

FIG. 2A is an underside view of the chassis of the vehicle of FIG. 1, showing illustrative components by which the vehicle can be elevated from controls located within the vehicle.

FIG. 2B is an underside view of the chassis of the vehicle of FIG. 1, showing alternative components by which individual wheels of the vehicle can be elevated from controls located within the vehicle.

FIG. 2C is a view illustrating the use of a lug gun operated from the components beneath the chassis for removing a flat tire from the vehicle.

FIG. 3A is a cross-sectional view of an illustrative lift mechanism in accordance with the invention.

FIG. 3B is a cross-sectional view of the lift mechanism of FIG. 3A in operative position.

FIG. 3C is an alternative lift mechanism in accordance with the invention.

FIG. 4A is an expanded view of the lift valve control of FIG. 2A.

FIG. 4B is an expanded view of an illustrative valve control mechanism for FIG. 2B.

FIG. 5 is a schematic of the driver actuatable controls of FIG. 1.

### DETAILED DESCRIPTION

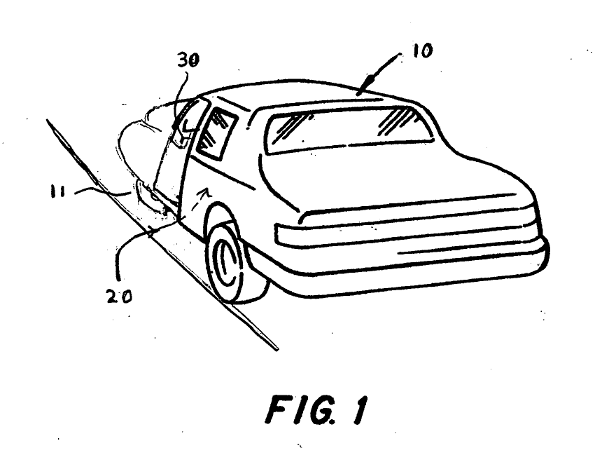

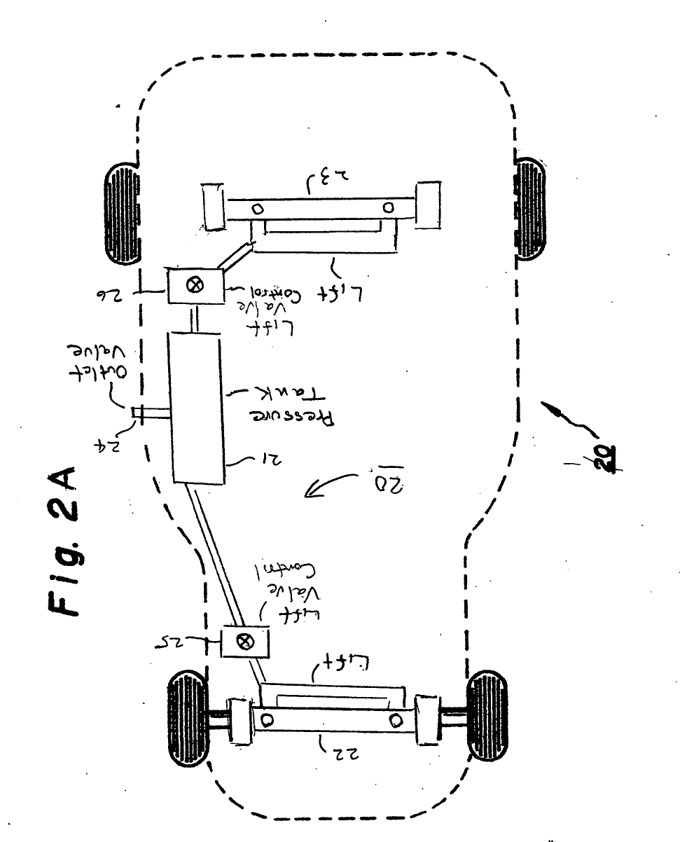

With reference to the drawings, in FIG. 1 the entire front 1 of a vehicle 10 has been elevated by a fluid actuated jack system 20, as detailed in FIG. 2A, that is at a fixed position beneath the vehicle 10 and operated from within the vehicle by driver actuatable controls 30.

As shown in FIG. 2A, the underside chassis of the vehicle of FIG. 1, includes the illustrative components of the fluid actuated jack system 20 by which the vehicle 10 can be elevated from the controls 30 located within the vehicle 10. The system 20 is formed by a fluid pressure tank 21 which extends to a front lift mechanism 22 and to a rear lift mechanism 23. In addition, an outlet valve 24 permits access to the pressure tank 21 for auxiliary uses of pressure, for example, by permitting the operation of a lug gun 50, as illustrated in FIG. 2C, by which the lug bolts of a conventionally mounted tire can be loosened preparatory to operation of the lift mechanism and by completely removing the loosened lug nuts after a wheel has been elevated.

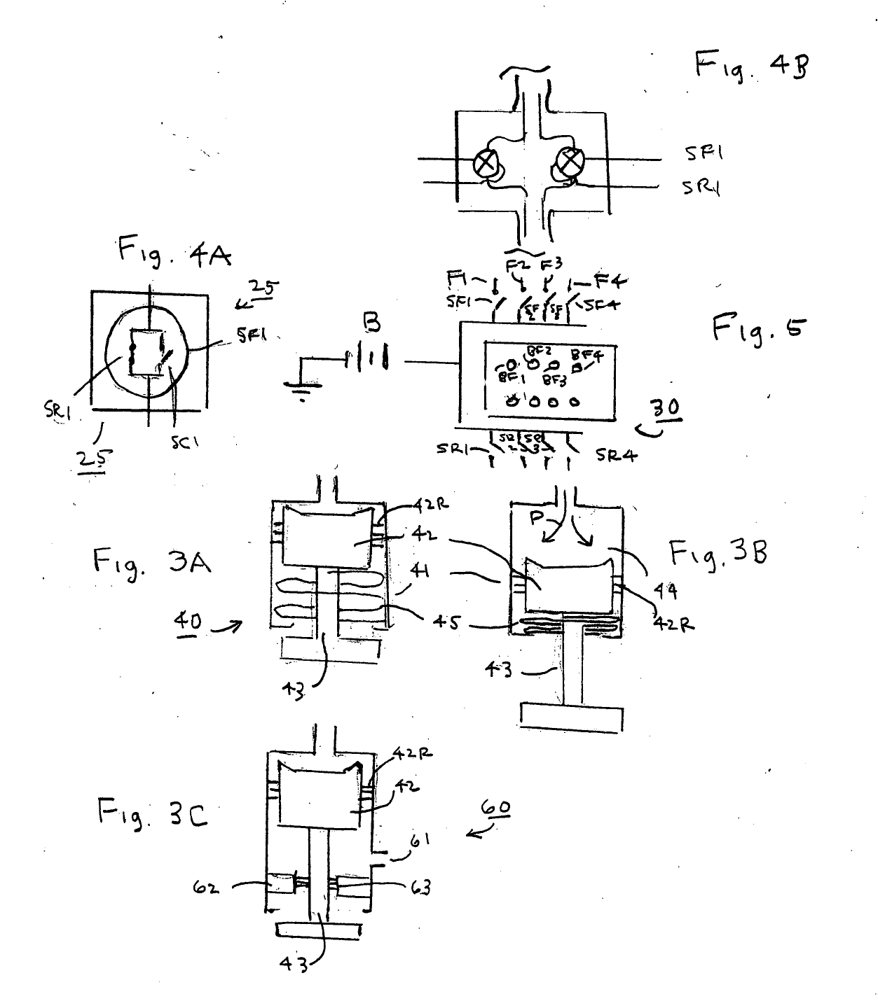

The pressure tank 21 is connected to the front lift 22 through a lift valve control 25 and a similar lift valve control 26 connects the pressure tank 21 to the rear lift 23. The lift valve controls 25 and 26 are operated from within the vehicle 10 by the driver actuatable controls 30, illustrated in FIG. 5.

In an illustrative embodiment of the invention for elevating a vehicle weighing approximately 3500 lbs., the pressure tank 21 can exert pressure on the order of about 150 lbs./square inch to realize 850 lbs. of lift at each tire position.

In FIG. 2A, the front lift mechanism 22 can be used to elevate the entire front portion of the vehicle 10, while the rear lift mechanism 23 is used to lift the entire rear portion of the vehicle 10. Where it is desired to provide for individual lifts of the vehicular wheels, the arrangement of FIG. 2B can be employed showing an underside view of the chassis of the vehicle 10 of FIG. 1, with alternative components by which individual wheels of the vehicle 10 can be elevated from controls 30 located within the vehicle 10.

Because an entire front or rear portion is elevated, the vehicle 10 the elevated portion is lifted from side to side thereof

On the matter of side to side elevation, the invention distinguishes over Martin, U.S. Pat. No. 5,722,641, issued Mar. 3, 1998 for “Vehicle Mounted Tire Changing System” (“Martin”).

Although Martin discloses a vehicle mounted tire changing system (10) having a hydraulic jack system (12) connected to a vehicle (14) for lifting a portion of the vehicle (14) relative to the supporting terrain (16) and a pneumatic system (18) carried by the vehicle (14) for connecting air operated tools, Martin does not teach or suggest using a gaseous source for both lifting a vehicle and operating tire changing tools. Martin's only use of a gaseous source is to operate tire changing tools. The invention can take advantage of a gaseous source to both change tires and lift a vehicle.

In FIG. 2B, the frontal lift mechanism 22 has been replaced by individual lift devices 27A and 27B for the simultaneous lelevation of the right front wheel 12A and the left front wheel 12B. Similarly, the rear lift mechanism 23 has been replaced by individual lift devices 28A and 28B for the simultaneous elevation of the right rear wheel 13A and the left rear wheel 13B.

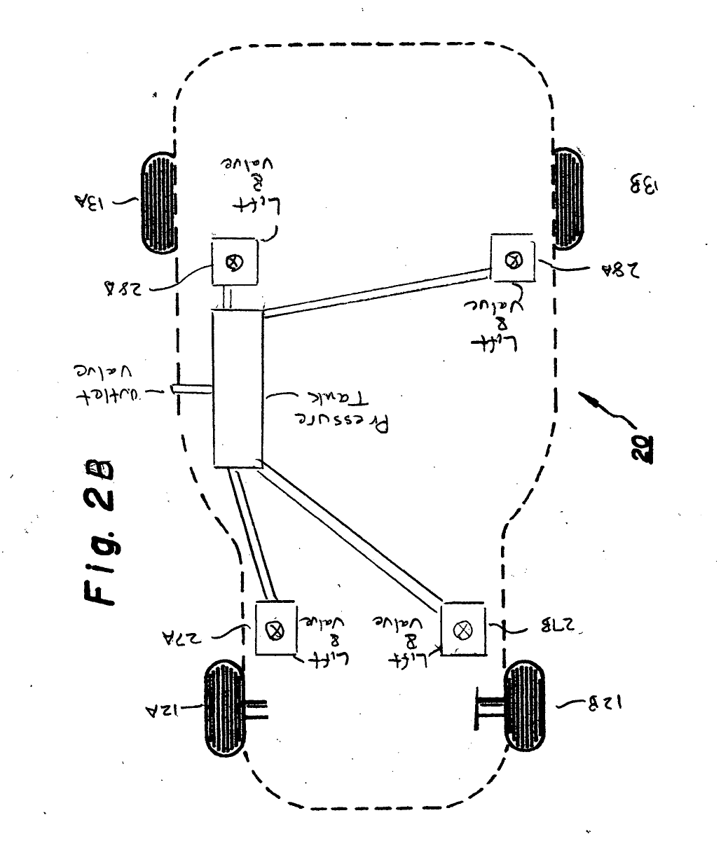

In FIG. 3A the cross-sectional view of an illustrative lift device 26A, B or 27A, B takes the form of a cylindrical system 40 with a shell 41 enclosing a piston 42 and a lift rod 43 that is acted upon by fluid pressure P that enters a cylindrical chamber 44, as shown in FIG. 3B, above the head 42H of the piston 42, which is sealed from the shell 41 by rings 42R. The piston 42 and the lift rod 43 are held in their elevated position by a spring 45 that is compressed when fluid P enters the chamber 44, after a signal is received from the controls 30. As a result, the lift rod 43 is extended so that a wheel 12A, B or 13A, B is elevated to permit use of the lug gun 50 at the connector 24 to complete removal of the lug nuts by which the wheel is mounted on the vehicle 10.

After an inflated replacement tire is positioned where the wheel 12A has been removed, the lift rod 43 returns to its original position within the cylinder 40 by the expansion of the spring 45.

In FIG. 3C, the cross-sectional view of an alternative lift device 60 in accordance with the invention provides for return of the lift rod 43 by omitting the spring 45 of FIGS. 3A and 3B, and instead using a bypass channel 61 to apply return fluid pressure to the piston 42 between a flange 62 that surrounds the lift rod 43 near the exit position of the device 60 and is slidably sealed to the lift rod 43 by a grommet 63 fixed to the flange 62.

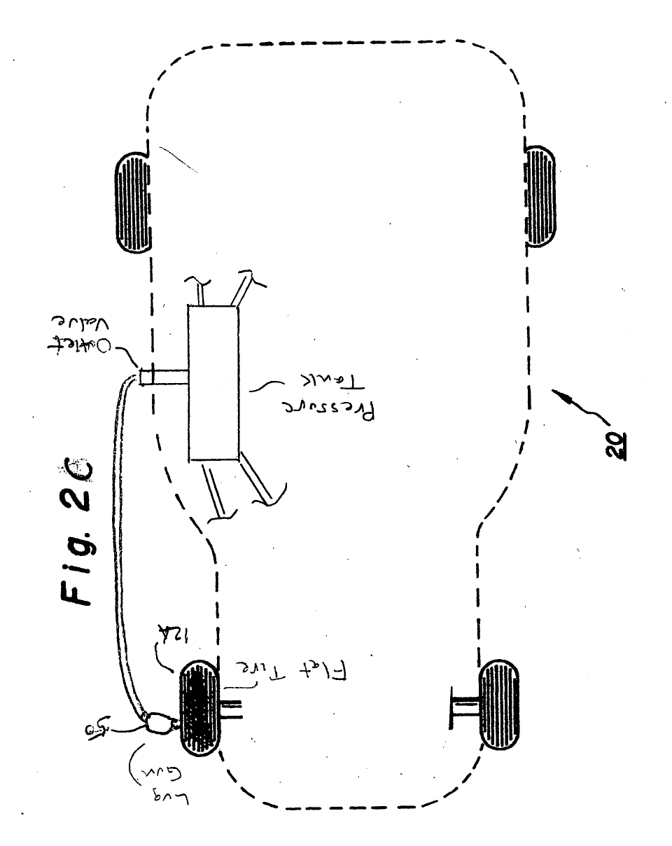

The control panel 30 mounted within the vehicle 10 to permit driver operation of the lift structures takes the form of fluid control connections F1-F4 and R1-R4 that are operated by buttons BF1-BF4 and BR1-BR4. When the button BF1 is pressed, it closes switch SF1 and the remaining buttons close counterpart switches SF2-SF4 and SR1-SR4. Closure of any switch applies a signal from the connected battery B of FIG. 5 to a lift valve control, thus the lift valve control 25 of FIG. 4A can be operated by switches SF1 and SR1. The signal from closure of SF1 closes a switch SC1 that permits the application of fluid pressure while a signal from closure of SR1 opens a switch SC2 and permits the return of fluid to the pressure tank 21 from the lift 22.

Where individual lifts such as 27A and 27B are employed, the control can take the form shown in FIG. 4B, where the lift controls 27A and 27B have been combined into a single unit.

Thus, an arrangement is made for permitting the control flow of pressure from the tank 21 to the lift mechanisms and release of pressure when the lift rod 43 is to be returned by spring action or by providing an alternative line to apply return fluid pressure when the spring 45 is not used.

In the case of comparatively large vehicles, such as trucks, the vehicles have installed compressors, which are used or are incorporated into the pressure tank 21 of FIG. 2A. For some vehicles the installed compressors can provide over 100 pounds per square inch of pressure and the compressor can be integrated into the pressure tank and be operated by a motorized arrangement (not shown).

In addition, the lift rods shown in FIGS. 3A-3C are in rod form but also can be arranged to be formed in telescopic segments that can be extended for lifting and retracted after the lift operation has been completed.

It is to be understood that the foregoing description is illustrative only and that modifications and adaptations of the invention, including, but not limited to, the use of equivalents, may be made by those of ordinary skill in the art without departing from the spirit and scope of the invention as defined in the appended claims.

1. Apparatus for elevating an object having a front portion and a rear portion, comprising;
means centrally secured beneath said object for the elevation thereof; and
means for operating the elevation means;
wherein said means for elevating comprises a single lift mechanism for selectively lifting the entire portions of said object.

2. Apparatus as defined in claim 1, wherein said elevating means comprises means for lifting said entire front portion.

3. Apparatus as defined in claim 1, wherein said elevating means comprises means for lifting said entire rear portion.

4. Apparatus as defined in claim 1, wherein said object has a chassis and said elevation means is centrally positioned beneath said chassis.

5. Apparatus as defined in claim 4, wherein said object is a vehicle and said elevation means comprises a source of fluid pressure connected to said means for elevating said vehicle.

6. Apparatus as defined in claim 5, wherein the elevating means comprises means for elevating a plurality of wheels of said vehicle simultaneously.

7. Apparatus as defined in claim 5, wherein said fluid pressure is selected from the class consisting of gaseous, liquid and hydraulic fluids.

8. Apparatus as defined in claim 5, wherein said source of fluid pressure is rechargeable.

9. A method of providing for the repair of a flat tire on a vehicle, comprising the steps of:
(a) Loosening said flat tire from said vehicle;
(b) Elevating said tire by means at a fixed position beneath said vehicle for the elevation of said flat tire wherein said means for elevating comprises a single lift mechanism for selectively lifting the entire front or back portion of said vehicle;
(c) Removing said flat tire from said vehicle at the elevated position of said tire;
(d) Replacing said flat tire by a suitably inflated tire on said vehicle;
(e) Lowering inflated said tire by said means at said fixed position beneath said vehicle.

10. A method for elevating an object having a plurality of sides, comprising the steps of:
(a) securing to said object centrally located means for the elevation selectively of an entire side of said object; and
(b) operating the elevation means.

11. The method as defined in claim 10, further including the step of positioning said elevation means beneath said object.

12. The method as defined in claim 11, further including the step of attaching said elevation means beneath a vehicle.

13. The method as defined in claim 12, further including the step of providing said elevation means with a source of fluid pressure.

14. The method as defined in claim 13, further including the step of connecting said source of fluid pressure to means for elevating said vehicle.

15. The method as defined in claim 14, further including the step of elevating a wheel of said vehicle.

16. The method as defined in claim 15, further including the step of applying fluid pressure to said elevating means in order to elevate said wheel of said vehicle.

17. The method as defined in claim 10 further including the step of applying gaseous fluid pressure to means for elevating said vehicle.

18. The method as defined in claim 10, further including the step of applying hydraulic fluid pressure.

19. The method as defined in claim 10, further including the step of externally recharging said source of fluid pressure.

20. The method as defined in claim 19, further including the step of providing said source of fluid pressure as a gaseous source
